(19) United States
(12) Patent Application Publication
(10) Pub. No.: US 2026/0084481 A1
(43) Pub. Date: Mar. 26, 2026

(54) RETAINING DEVICE FOR A STABILIZER FOR A MOTOR VEHICLE

(71) Applicant: MUHR UND BENDER KG, Attendorn (DE)

(72) Inventors: Filip HLUZIN, Prerov (CZ); Ales MURON, Olomouc (CZ); Marko LIETZ, Schwerte (DE); Michal SIBL, Prostejov (CZ); Lubos PECENKA, Choryne (CZ)

(73) Assignee: MUHR UND BENDER KG, Attendorn (DE)

(21) Appl. No.: 19/333,188

(22) Filed: Sep. 18, 2025

(30) Foreign Application Priority Data
Sep. 20, 2024 (DE) 102024127272.4

(51) Int. Cl. B60G 21/055

(52) U.S. Cl. CPC B60G 21/0551; B60G 2206/7101

(57) ABSTRACT

A retaining device for a stabilizer for a motor vehicle includes an arc section with at least one central sprue area, at least one rib structure formed in the arc section around the sprue area with a plurality of ribs and a plurality of recesses formed between the ribs, wherein the ribs of the rib structure are arranged such that, in a top view of the sprue area, the recesses lie on at least two circular lines with different radii arranged concentrically around the sprue area, wherein at least three recesses are arranged in circumferential direction around the sprue area.

### CROSS-REFERENCE TO RELATED APPLICATIONS

This application claims priority to German Patent Application No. DE 102024127272.4 filed Sep. 20, 2024, the disclosure of which is hereby incorporated in its entirety by reference herein.

### TECHNICAL FIELD

The disclosure relates to a retaining device for a stabilizer for a motor vehicle with an arc section and a rib structure provided in the arc section with several ribs and several recesses formed between the ribs. The disclosure also relates to a bearing for a stabilizer for a motor vehicle.

### BACKGROUND

Such retaining devices are used as part of a bearing to attach a stabilizer bar to a chassis.

From U.S. Pat. No. 11,440,371 B2 for example, a bearing for a stabilizer bar of a vehicle is known, which has a flange with at least one retaining section and a cellular structure. Further retaining devices are disclosed, for example, in DE 10 2015 004 466 B3, WO 2019/025728 A1, WO 2010/149756 A1, DE 10 2013 201 058 A1, US 2020/238784 A1, DE 10 2019 003 884 A1 and U.S. Pat. No. 11,440,371 B2.

### SUMMARY

Disclosed herein is a retaining device for a stabilizer that provides high stability with fast and cost-effective production.

In one or more embodiments, the retaining device for a stabilizer for a motor vehicle, includes an arc section with at least one central sprue area and at least one rib structure around the sprue area in the arc section with several ribs and several recesses formed between the ribs. The ribs of the rib structure may be arranged in such a way that, when viewed from above, the recesses in the sprue area are located on at least two concentric circular lines with different radii around the sprue area. According to the invention, at least three recesses, in particular at least four recesses, are distributed circumferentially around the sprue area on a smallest circular line around the sprue area.

The rib or web structure provides material and thus cost savings in the production of the retaining device. By forming the rib structure of the arc section, in plan view of the sprue area, in concentric circles around a central sprue area, a flowable material, for example a plastic melt, can be distributed quickly and evenly in a mold, in particular a cavity of an injection molding tool, during production of the retaining device. The arrangement of the recesses of the rib structure on circular lines arranged concentrically around the central sprue area enables improved material flow. By arranging at least three or four recesses circumferentially around the sprue area, the stability of the holding device can also be improved and the required material can be saved.

Preferably, the recesses respectively the web areas formed therebetween are designed in such a way that the geometry has particular low resistance and uniform wall thickness. Particularly favorable are approximately uniform web cross-sections with few deflections along the flow path, which contributes to a reduction in material filling and back pressure. By reducing the filling pressure required for injection molding, the number of product cavities per mold and/or per mold surface can be increased at a given maximum machine pressure. This leads to higher output and efficiency.

The retaining device is designed to attach a stabilizer bar to the chassis of a motor vehicle. For example, the retaining device can be designed in the form of a mounting bracket. It may also be referred to as stabilizer bracket, holding device, mounting device or bearing. To accommodate a rubber bearing for the stabilizer, the retaining device has an arc section, i.e. a curved section that spans an opening for accommodating the rubber bearing. The retaining device can be manufactured using an injection molding process. In the case of continuous recesses, the rubber bearing can engage therein in a form-fitting manner, thereby a forming a geometric interlocking connection.

The sprue area is in particular centrally located, i.e. when viewed from above the sprue area, it is located in the middle of the arc section. The sprue area refers to an area around a sprue point of the retaining device that is bounded, respectively delimited by the recesses of the rib structure. The sprue point describes the point at which the arc section, in particular the retaining device, was molded during manufacture, in particular during injection molding. The sprue point can be formed, for example, in the form of a recess and/or elevation on the surface of the sprue area.

The rib structure comprises the ribs and recesses formed in the arc section. The ribs of the rib structure run towards the sprue area in such a way that the recesses lie at least partially on concentric circular lines. Concentric means that the circular lines have the sprue area, in particular the sprue point located in the sprue area, as their respective circle centers. Or, in other words, at least a plurality of the recesses are arranged on concentric circular lines, with the sprue area including the circle centers of the circular lines. The circular lines can have a circular or elliptical circumference and may also be referred to as ring lines.

The circular lines indicate fictitious assignment lines for the recesses defined by the design of the rib structure. The ribs of the rib structure run, for example, at least partially in a radial direction and in a circumferential direction around the sprue area. The recesses are free areas of the arc section bounded, respectively formed by one or more ribs. The ribs are formed around the sprue area in such a way that, when viewed from above, the recesses lie on several circular lines with different radii. The top view of the sprue area refers to a vertical view of the sprue area. At least four recesses are distributed in the circumferential direction around the sprue area, i.e. preferably on a circle with the smallest radius to the sprue point, i.e. the smallest circle. The at least four recesses can be arranged at equal distances from each other or, alternatively, at random distances in the circumferential direction around the sprue area.

According to an embodiment, the total volume of all recesses may be greater than 30%, in particular greater than 40% particular, of the total volume of the material of the arc section, in particular of the total volume of the material of the retaining device. A maximum value for the volume ratio of the total recess volume to the total envelope volume may be 60 %, for example. The total volume of all recesses in the rib structure can be adjusted, for example, by the shape of the recesses or the number of recesses. A large hollow volume in relation to the material volume promotes fast production with high efficiency in plastic injection molding.

The design of the rib structure, in particular the ribs and recesses, can be supported, for example, by means of an FEM calculation or other simulation calculations, so that the rib structure still has the required stability for the respective application even with a high number of recesses, for example more than 70, depending on the wall thickness. Due to the relatively large total cavity of all recesses, which results from the shape and/or number of recesses, the amount of material required for the retaining device and, accordingly, the manufacturing costs of the retaining device can be reduced even further. In addition, the savings in the required material result in a reduction in production times, as a mold for the holding device can be filled more quickly with the flowable material.

According to a possible embodiment, the ribs of the rib structure can be arranged in such a way that the recesses of a first circular line are at least partially offset in the circumferential direction relative to the recesses of a radially adjacent circular line. The radially adjacent circular line is understood to be a second circular line with a second radius that is smaller or larger than the first radius of the first circular line. In this context, partially offset means that at least a subset of the recesses arranged on the first circular line is offset in the circumferential direction relative to the recesses of the radially adjacent circular line. It is also possible that all recesses on the first circular line are offset in the circumferential direction relative to the recesses on the radially adjacent circular line.

Hereinafter, the recesses arranged on the first circular line are referred to as first recesses and the recesses arranged on the second circular line are referred to as second recesses. For example, the first recesses are arranged offset in the circumferential direction relative to the second recesses in such a way that a first recess of a subset of the first recesses is at least partially arranged in circumferential direction between two adjacent second recesses. In this context, “partially” means that at least a portion of the first recesses of the subset is arranged in a circumferential area between two adjacent second recesses. The first recesses may be arranged completely in circumferential direction between two second recesses, with overlapping being possible.

In addition, the recesses of a third circular line radially adjacent to the first and/or second circular line may be arranged at least partially offset in the circumferential direction relative to the first or second recesses. Further recesses arranged on a circular line radially adjacent to the first, second and/or third circular line may each be arranged offset in the circumferential direction. The fact that the recesses of radially adjacent circular lines are offset from each other in the circumferential direction allows the flow direction of the material to be optimized when casting respectively molding the retaining device, so that a mold can be filled more quickly and evenly. This further reduces the manufacturing time and, consequently, the manufacturing costs.

According to a possible embodiment, the arc section may have an inner face for receiving a rubber bearing and an outer face. The width, i.e. axial length of the arc section and/or rubber bearing may be between 25 and 75 mm, for example. The inner face may extend in an arc around a longitudinal axis and define a central axis perpendicular thereto, on which the sprue area is arranged. The inner face and the outer face of the arc section are arranged at a distance from each other in the radial direction to the longitudinal axis. The distance between the inner face and the outer face defines the thickness of the arc section. The arc section may include a wall formed between the inner face and a bottom face of the recesses. The thickness of the wall may be between 3 and 14 mm, for example. In terms of width, the arc section extends in the axial direction, respectively parallel to the longitudinal axis. The opening of the arc section is defined by the inner face. The rubber bearing can be accommodated in the opening of the arc section. The central axis is arranged perpendicular to the longitudinal axis and can be centered in relation to the axial extension, respectively width of the retaining element. The sprue area can be arranged on the central axis on the outer face or inner face of the arc section. The central axis and the longitudinal axis define or span a central plane, which can also be referred to as a plane of symmetry. Preferably, the sprue point can be arranged on the central axis.

According to an embodiment, the recesses may penetrate the arc section, or in other words extend through the arc section from the outer face to the inner face. In this case, the recesses may be formed as free areas, respectively through holes of the arc section extending from the outer face to the inner face. The inner face may have a grid structure interrupted by the recesses and formed by the ribs, so that at least the arc section does not have a continuous supporting wall for the rubber bearing. As the recesses interrupt the inner face of the arc section, a mechanical interlocking is provided between the rubber bearing and the retaining device, as the rubber material is pressed into the recesses. This can counteract relative movements between the rubber bearing and the retaining device.

The recesses are in particular designed such that their geometry provides little resistance to the flow of material during injection molding. For this purpose, at least a plurality of recesses, arranged on at least the smallest circle line and a further circle line, in particular on at least the three smallest circle lines, may be formed as non-circular, in particular drop-shaped or elliptical recesses when viewed from above the sprue area. Drop-shaped means in particular that a recess has a continuous, one-sided pointed or small radius rounded perimeter, respectively circumference. Rounded sections of the recesses preferably have a radius of more than 0.25 mm, preferably more than 0.5 mm. The use of non-circular recesses applies preferably to at least 60%, at least 80% or all of the recesses on the smallest two and/or three circular lines. The non-circular recesses are preferably arranged radially around the sprue area. This means that the recesses with their largest opening extensions are arranged on radial rays emanating from the sprue area or at an acute angle thereto. A subset of recesses may also be circular, honeycomb-shaped and/or polygonal, for example triangular or rectangular.

The recesses arranged on a circular line may have one or more of these shapes. Drop-shaped recesses may be arranged such that a tip of the drop shape formed by the converging circumference portions is aligned radially towards the sprue area, in particular to the sprue point, or in the opposite direction. Furthermore, regardless of their respective shape, the recesses may each have rounded corners in order to further improve the distribution of the flowable material when casting, respectively injection molding the retaining device. Determining the shape and its position on the arc section can also be supported by FEM calculation or other simulation calculations. The variable shape of the recesses can help to optimize the arrangement and orientation of the recesses on the arc section.

According to a further embodiment, the rib structure may have recesses on several circular lines, with at least twice as many recesses on the largest circular line as on the smallest circular line. The smallest circular line refers to the circular line with the smallest radius to the sprue area, in particular the sprue point. The at least four recesses can be arranged on the smallest circular line. In this context, the largest circular line is understood to be the last circular line on which recesses are arranged distributed over its entire circumference. The largest circular line can have the largest radius around the central axis. The largest radius can be less than half the axial width of the arc section.

At least four, six or eight recesses may be arranged on the smallest circle. Accordingly, at least eight, twelve or sixteen recesses may be provided on the largest circle. It is also possible that at least three times as many recesses are provided on the largest circle than on the smallest circle. For example, eight recesses may be arranged on the smallest circle and 24 recesses on the largest circle.

It is also possible that recesses are provided on further circular lines extending beyond the largest circular line, particularly in the area of the side sections. However, due to the limitation imposed by the axial width of the arc section, fewer recesses are arranged on these circular lines. The rib structure may preferably have three to twelve, three to ten or four to nine circular lines with increasing radii with respect to the sprue area. This may also include circular lines whose circumference, when viewed from above the sprue area, is not completely arranged on the arc section.

The holding device may have two support sections formed at opposite ends of the arc section, with each support section having an opening for arranging and/or inserting a connecting element. The rib structure may enclose the openings at least halfway in circumferential direction. The support sections are each formed at the ends of the arc section. The openings may preferably be arranged transversely, in particular at a distance perpendicular to the longitudinal axis, and parallel to the central axis respectively. Furthermore, a circular rib surrounding the openings may be provided on each of the support sections for reinforcement. In plan view of the arc section, the openings of the support sections are respectively enclosed at least halfway in circumferential direction by the recesses of the rib structure.

The support sections may each have a support face for arranging the holding device on a carrier part of the chassis of the motor vehicle. The support faces may each be free of a rib structure in order to maximize the connection face between the holding device and the support face of the chassis. The support sections enable simple and reliable mounting of the holding device on the chassis. By also enclosing the openings of the support sections with the rib structure, the amount of material required for the holding device can be further reduced.

According to an embodiment, the arc section and the support sections can be formed in one piece from a fibre-reinforced plastic. The arc section can merge into the support sections without edges, at least on the outer face, in order to improve the flow of material from the arc section into the support sections when the holding device is injection molded. The arc section and the support sections can be made of polyamide or PET.

The fibers may be glass fibers. Alternatively or additionally, the fibers may be carbon fibers and/or aramid fibers. The fibers may be formed as short fibers with a length of less than 5 mm, or in particular between 2.5 and 3.5 mm. The diameter of the fibers can be between 0.1 and 0.5 mm, in particular between 0.2 and 0.3 mm. When glass fibers are used, the fiber-reinforced plastic can contain for example 30 to 50 weight percent of fibers, in particular 35 to 45 weight percent.

The fibers can reinforce the mechanical strength of the retaining device. By arranging the sprue area, in particular the sprue point, centrally in or on the arc section, radial alignment of the fibers relative to the sprue area can be achieved. The overlap of the recesses on two radially adjacent circular lines enables improved distribution of the plastic melt and also alignment of the fibers in the circumferential direction around the sprue area.

The ribs, respectively the web areas can be arranged such that at least some of the recesses arranged on different circular lines overlap radially when viewed from above the sprue area. The recesses of radially adjacent circular lines, for example the first and second circular lines, can overlap radially when viewed from above the sprue area. The radial overlap can be achieved by the shape of the recesses and/or the ratio of the radii of the adjacent circular lines. For example, an elliptical or teardrop-shaped first recess can be arranged to overlap radially with a second recess. Alternatively or additionally, the radius of the first circular line can be only slightly smaller than the radius of the second circular line.

At least some of the recesses refers to a proportion of the recesses arranged on a circle, for example a quarter, a third or half of the recesses. It is also possible for all recesses of a circular line to be arranged radially overlapping a radially adjacent circular line. The radial overlap of the recesses of different circular lines, which can be provided alternatively or in addition to the overlap in the circumferential direction, can further increase the possible number of recesses on the arc section and/or the support sections.

The sprue area can be circular or cylindrical in shape and have a larger diameter than the thickness of the ribs. In this context, circular means that the sprue area can have a polygonal, for example 4-sided to 12-sided, or round perimeter when viewed from above. The diameter of the sprue area can refer to the diameter of a round perimeter or the edge distance between opposite edges of a polygonal circumference. The recesses can have side walls adjacent to the ribs, which are arranged in particular parallel to the central axis and/or perpendicular to the longitudinal axis of the arc section. The thickness of the ribs refers to the distance between two recesses separated by a rib. Because the thickness of the ribs is less than the diameter of the sprue area, the possible number of recesses formed on the arc section and/or the support sections can be further increased, thereby further reducing the amount of material required for the retaining device.

According to a further implementation, the arc section may have two or more sprue areas, with the recesses of the rib structure lying on circular lines arranged concentrically around the respective sprue area when viewed from above. It may be necessary for the arc section to have more than one sprue area, in particular if it has been injection molded at more than one sprue point. The sprue areas may be arranged at different positions on the inner face or the outer face of the arc section. The recesses of the rib structure are disposed on circular lines, each of which runs concentrically to different sprue areas, in particular sprue points. The recesses on circular lines of different sprue points may be arranged so that they overlap radially. Multiple sprue areas, in particular sprue points, facilitate, for example, more flexible adjustments of the material flow during an injection molding process and/or the combination of multiple plastic materials.

The invention further relates to a bearing for a stabilizer for a motor vehicle with a retaining device, a base part and a rubber bearing arranged between the arc section of the retaining device and the base part. The base part and the arc section form a receptacle for the rubber bearing. The stabilizer can be mounted in the rubber bearing between the base part and the retaining device.

### BRIEF DESCRIPTION OF THE DRAWINGS

Preferred embodiments of a retaining device according to the invention are described below with reference to the drawings. The drawings are schematic representations, with:

FIG. 1 showing a perspective view of a retaining device according to the invention for a stabilizer for a motor vehicle chassis, with a rib structure;

FIG. 2 showing a top view of the retaining device from FIG. 1;

FIG. 3 showing a perspective view of a retaining device with a modified rib structure analogous to FIGS. 1 and 2;

FIG. 4 showing a top view of the retaining device of FIG. 3;

FIG. 5 showing a top view of a retaining device with a further modified rib structure analogous to FIGS. 1 to 4; and

FIG. 6 showing a cross-section through a bearing for a stabilizer for a motor vehicle chassis, with the retaining device from FIGS. 1 and 2.

### DETAILED DESCRIPTION

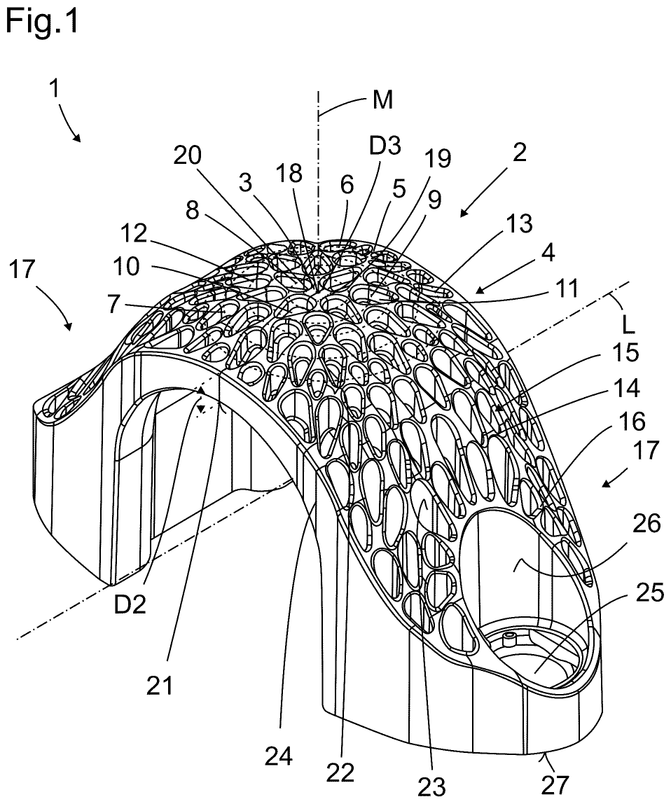

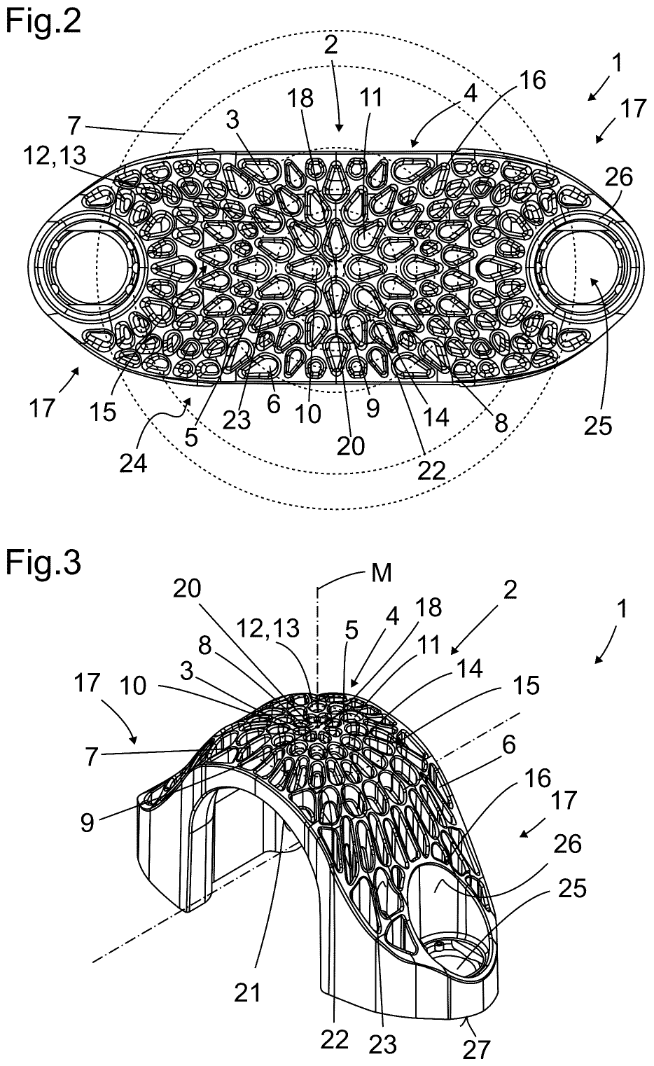

FIGS. 1 and 2 show an example retaining device 1 for a stabilizer 30 for a motor vehicle. The retaining device 1 has an arc section 2 with a central sprue area 3 and a rib structure 4 formed in the arc section 2 around the sprue area 3. The rib structure 4 has several ribs 5 and several recesses 6 formed between the ribs 5.

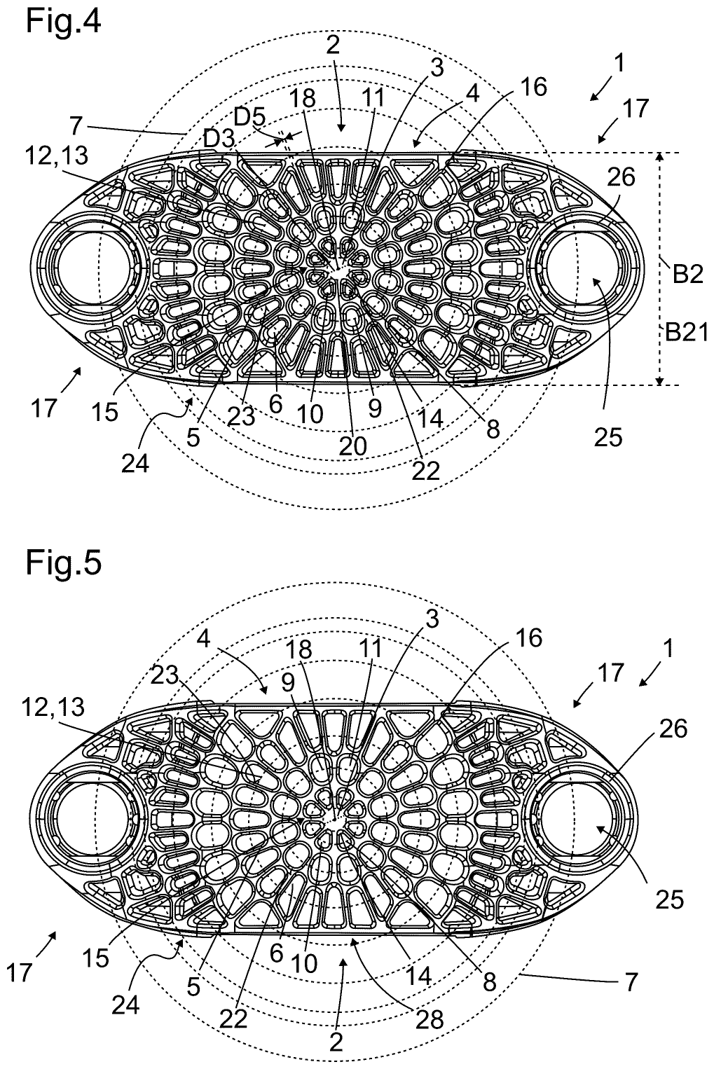

The ribs 5 of the rib structure 4 are arranged such that, when viewed from above, the recesses 6 lie on several concentric circular lines 7 (see FIGS. 4 and 5) with different radii around the sprue area 3 and/or a sprue axis.

In this embodiment, for example four recesses 6 are arranged in circumferential direction around the sprue area 3 which may also be referred to as gating area. These recesses 6 are arranged on a circular line with the smallest radius to the sprue point and/or sprue axis, i.e. the smallest circular line 8. The recesses 6 on the smallest circular line 8 can be arranged at equal distances from each other or, alternatively, at random distances in the circumferential direction around the sprue area 3. Here, the recesses 6 on the smallest circular line 8 are arranged at an angle of 90° from each other around the sprue area 3.

The total volume of all recesses 6 relative to the total volume of the material of the retaining device 1 is greater than 30%, in particular greater than 40 %. The rib structure 4 has 80 to 140 recesses 6, in this case, for example, 135 recesses 6. The ribs 5 of the rib structure 4 are arranged in such a way that the recesses 6 of the first, smallest circular line 8 are at least partially offset in the circumferential direction relative to the recesses 6 of a radially adjacent second circular line 9. The second circular line 9 has a second radius that is larger than the first radius of the first circular line 8.

The rib structure has 3 to 14, in this embodiment for example 14, circular lines 7 with increasing radii with respect to the sprue area 3. The recesses 6 arranged on the first circular line 8 are designated as first recesses 10 and the recesses 6 arranged on the second circular line 9 are designated as second recesses 11.

Further, recesses 6 of a third circular line 12 radially adjacent to the first and/or second circular lines 8, 9 may be arranged at least partially offset in the circumferential direction relative to the first recesses 10 and/or the second recesses 11. Further recesses 6 arranged on a circular line 7 radially adjacent to the first, second and/or third circular lines 8, 9, 12 may each be arranged offset in the circumferential direction.

The recesses 6 of radially adjacent circular lines 7, for example the first and second circular lines 8, 9, can be arranged so that they overlap radially when viewed from above the sprue area 3. The radial overlap can be achieved by the shape of the recesses 6 and/or the ratio of the radii of the adjacent circular lines 7.

The largest circular line 13 has at least twice as many recesses 6 as the smallest circular line 8. The largest circular line 13 is understood to be the last circular line 7 on which recesses 6 are arranged distributed over its entire circumference. The largest circular line 13 is formed by the largest radius, which can be a bit smaller than half the axial width of the arc section 2. At least eight, in this case for example 18, recesses 6 are arranged on the largest circular line 13.

The recesses 6 are for example circular, honeycomb-shaped and/or drop-shaped in plan view on the sprue area 3 (as shown in FIGS. 4 and 5). Alternatively or in addition, the recesses 6 can be elliptical and/or polygonal in plan view on the sprue area 3, for example triangular or rectangular.

The recesses 6 arranged on a circular line 7 may have one or more of these shapes. Drop-shaped recesses 6 may be arranged such that a tip 14 of the drop shape 15 formed by the tapered circumference is aligned radially towards the sprue area 3, respectively the sprue axis, or in the opposite direction thereto. Furthermore, the recesses 6 may have rounded corners 16, regardless of their respective shape.

The design of the rib structure 4, for example the design of the shape of the recesses 6 and their position on the arc section 2, can be supported by FEM calculation or other simulation calculations.

The retaining device 1 is formed in one piece, i.e. integrally formed from fiber-reinforced plastic, with a support section 17 being formed at each end of the arc section 2. The sprue area 3 is located centrally, i.e. in the middle of the arc section 2, when viewed from above the sprue area 3. The sprue area 3 refers to an area around a sprue point 18 of the retaining device 1 that is bounded by the recesses 6 of the rib structure 4. The sprue area 3 has a larger diameter D3 than the thickness D5 of the ribs 5. Here, the diameter D3 of the sprue area 3 refers to the edge distance between opposite edges 19 of a polygonal perimeter 20 of the sprue area 3.

The arc section 2 has an inner face 21 for receiving a rubber bearing and an outer face 22. The inner face 21 extends in an arc around the longitudinal axis L and defines a central axis M perpendicular thereto. The sprue area 3 is arranged on the central axis M. The inner face 21 and the outer face 22 of the arc section 2 are arranged at a distance from each other in the radial direction to the longitudinal axis L. The distance between the inner face 21 and the outer face 22 defines the thickness D2 of the arc section 2. At the outer surface 22, the arc section 2 merges into the support sections 17, in particular without edges. The recesses 6 each have side walls 23 adjacent to the ribs 5, which are arranged parallel to the central axis M and/or perpendicular to the longitudinal axis L of the arc section 2. The thickness D5 of the ribs 5 refers to the distance between two recesses 6 separated from each other by a rib 5.

The arc section 2 extends in its width B2 parallel, respectively in axial direction to the longitudinal axis L. The central axis M arranged perpendicular to the longitudinal axis L and axially centered with respect to the width B21 of the inner face 21. The sprue area 3 can be arranged on the central axis M, as shown here, for example, on the outer face 22 or on the inner face 21 of the arc section 2. The sprue point 18 is arranged on the central axis M.

The support sections 17 are formed transversely, in particular perpendicular to the longitudinal axis L, at each end 24 of the arc section 2. Each support section 17 comprises an opening 25 for mounting a connecting element. The openings 25 run parallel to the central axis M and with a distance perpendicular to the longitudinal axis L. A circular rib 26 surrounding the openings 25 is provided on each of the support sections 17 for reinforcement. Viewed in plan view, the openings 25 of the support sections 17 are each surrounded over at least half the circumference by recesses 6 of the rib structure 4. The support sections 17 each have a support face 27 for arranging the retaining device 1 on a mounting face of the chassis of the motor vehicle.

FIG. 4 shows a second embodiment of a retaining device 1 according to the invention, which is slightly modified compared to the holding device shown in FIGS. 1 and 2. Thus, the same reference signs are used for identical or corresponding components and/or elements. The retaining device 1 shown in FIG. 4 differs from the retaining device 1 shown in FIGS. 1 and 2 in that the sprue area 3 and the rib structure 4 are designed differently. The sprue area 3 is circular in shape. The ribs 5 and recesses 6 of the rib structure 4 have alternative orientations, shapes and arrangements relative to the sprue area 3.

FIG. 5 shows a third embodiment of a retaining device 1 according to the invention, which is slightly modified compared to the holding device shown in FIGS. 1 to 4. Again, corresponding components and/or elements are designated by the same reference signs used in the above Figures. The retaining device 1 shown in FIG. 5 differs from the retaining device 1 shown in FIGS. 1 and 2 in that the recesses 6 penetrate the arc section 2 from the outer face 22 to the inner face 21, i.e. they form through-openings. In this embodiment, the recesses 6 of the four circular lines 7, arranged around the first circular line 8 with increasing radius, penetrate the arc section 2, i.e. form through-openings therethrough. The inner face 21 has a grid structure 28 interrupted by the recesses 6 and formed by the ribs 5.

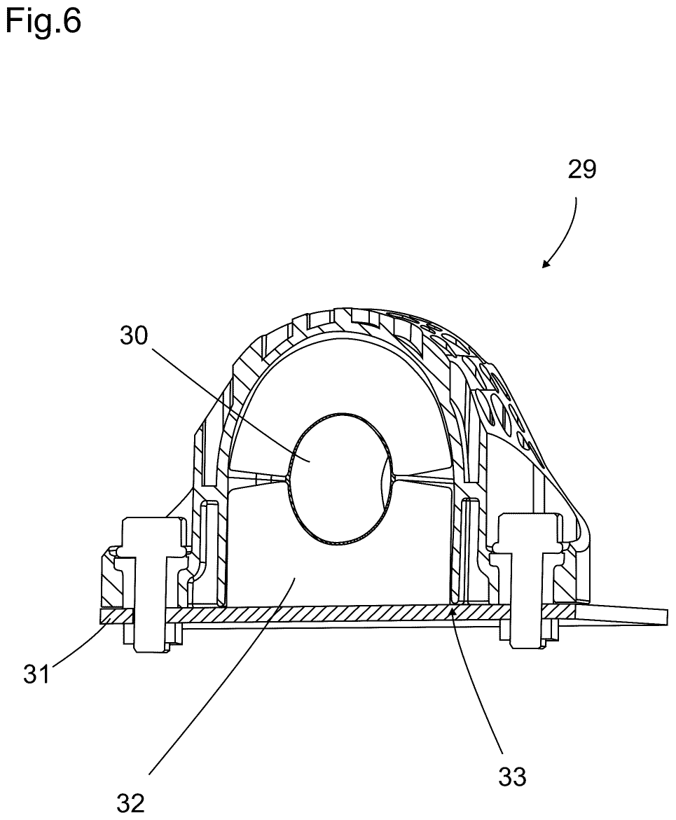

FIG. 6 shows a bearing 29 for a stabilizer 30 for a motor vehicle with the retaining device 1, a base part 31 and a rubber bearing 32 arranged between the arc section 2 of the retaining device 1 and the base part 31. The base part 31 and the arc section 2 form a receptacle 33 or mounting for the rubber bearing 32. The stabilizer 30 is mounted in the rubber bearing 32 between the base part 31 and the retaining device 1.

All features described in connection with individual embodiments of the invention may be provided in different combinations for the retaining device 1 and the bearing 29 in order to realize their advantageous effects, even if they have been described in different embodiments. For example, the recesses 6 of the retaining device 1 shown in FIGS. 1 and 2 may also penetrate the arc section 2 up to the inner face 21. Furthermore, two or more sprue areas 3 may also be provided in all embodiments. In this case, the recesses 6 of the rib structure 5 are arranged, viewed from above the sprue areas 3, on circular lines 7 arranged concentrically around the respective sprue area 3. The sprue areas 3 may be arranged at different positions on the inner face 21 or the outer face 22 of the arc section 2 or on the support sections 17.

What is claimed is:

1. A retaining device for a stabilizer for a motor vehicle, comprising:
an arc section with at least one sprue area; and
at least one rib structure formed in the arc section around the sprue area with a plurality of ribs and a plurality of recesses between the ribs,
wherein the ribs of the rib structure are arranged such that, in a top view of the sprue area, the recesses lie on at least two circular lines with different radii arranged concentrically around the sprue area,
wherein at least three recesses are arranged circumferentially around the sprue area on a smallest circular line having a smallest radius.

2. The retaining device according to claim 1, wherein the total volume of all recesses is in a ratio of greater than 30% to the total volume of the material of the arc section.

3. The retaining device according to claim 1, wherein the ribs of the rib structure are arranged such that the recesses of a first circular line are at least partially offset in circumferential direction relative to the recesses of a radially adjacent circular line.

4. The retaining device according to claim 1, wherein the arc section has an inner face for receiving a rubber bearing and an outer face, wherein the inner face extends in an arc around a longitudinal axis and defines a central axis perpendicular thereto, wherein the sprue area being arranged on the central axis.

5. The retaining device according to claim 4, wherein the recesses penetrate the arc section from the outer face to the inner face.

6. The retaining device according to claim 1, wherein at least a plurality of the recesses arranged on at least the smallest circular line and a further one of the at least two circular lines, are formed as non-circular, in particular drop-shaped or elliptical, recesses when viewed from above the sprue area, wherein the non-circular recesses are orientated radially around the sprue area.

7. The retaining device according to claim 1, wherein the rib structure includes recesses on several of the circular lines, the recesses being designed and distributed such that web portions formed therebetween have at least largely a uniform wall thickness.

8. The retaining device according to claim 1, wherein the wall thickness of the web portions is at least 1.5 mm and at most 2.5 mm.

9. The retaining device according to claim 1, wherein two support sections are formed at ends of the arc section, each of which has an opening for arranging a connecting element, wherein the rib structure surrounds the openings at least halfway respectively.

10. The retaining device according to claim 9, wherein the arc section and the support sections are formed integrally from a fibre-reinforced plastic.

11. The retaining device according to claim 1, wherein the ribs of the rib structure are arranged such that at least some of the recesses arranged on different circular lines are arranged to overlap radially when viewed from above the sprue area.

12. The retaining device according to claim 1, wherein the arc section has two or more sprue areas, wherein in plan view of a respective sprue area, the recesses of the rib structure lie on circular lines arranged concentrically around said sprue area.

13. A bearing for a stabilizer of a motor vehicle, the bearing comprising:
a retaining device including:
an arc section with at least one sprue area, and
at least one rib structure formed in the arc section around the sprue area with a plurality of ribs and a plurality of recesses between the ribs, wherein the ribs of the rib structure are arranged such that, in a top view of the sprue area, the recesses lie on at least two circular lines with different radii arranged concentrically around the sprue area, and wherein at least three recesses are arranged circumferentially around the sprue area on a smallest circular line having a smallest radius;
a base part; and
a rubber bearing arranged between the arc section of the retaining device and the base part.
